(19) United States
(12) Patent Application Publication
(10) Pub. No.: US 2008/0301189 A1
(43) Pub. Date: Dec. 4, 2008

(54) SYSTEM AND METHOD FOR PROVIDING A REAL-TIME CONTENT DISTRIBUTION NETWORK

(75) Inventors: Richard M. Petit, Plainville, CT (US); George D. Roberts, Bristol, CT (US)

Correspondence Address: THELEN REID BROWN RAYSMAN & STEINER LLP, PO BOX 640640, SAN JOSE, CA, 95164-0640, US

(73) Assignee: ADS HOLDINGS, LLC., Plainville, CT (US)

(21) Appl. No.: 12/130,108

(22) Filed: May 30, 2008

Related U.S. Application Data
(60) Provisional application No. 60/941,012, filed on May 31, 2007.

(51) Int. Cl. G06F 17/00; G06F 17/30

(52) U.S. Cl. 707/104.1; 707/E17.009

(57) ABSTRACT

A system and method for providing a real-time content distribution network. The system includes a player device at a host location. The player device includes a network interface for communicating with a content provider server device via a network, one or more speakers, and a computer processor in communication with the network interface and the one or more speakers. The computer processor includes instructions for facilitating receiving a playlist from the content provider server device in response to a request from the player device for an updated playlist. The instructions further facilitate accessing the audio media files specified by the playlist. In addition a play queue including all or a subset of the audio content included in the audio media files is built, with the building being responsive to local play sequence rules and to the attributes. Further, the audio content of the play queue is broadcast at the speakers.

### CROSS-REFERENCE TO RELATED APPLICATIONS

The present application claims the benefit of provisional application No. 60/941,012 filed May 31, 2007, the content of which is hereby incorporated by reference in its entirety.

### BACKGROUND

Exemplary embodiments relate generally to location-based advertising, and more particularly, to systems and methods for providing a real-time content distribution network.

Companies routinely spend thousands of dollars on producing, monitoring and managing advertising campaigns in an attempt to capture the attention and maximize the response from a selected or target audience. Advertisers attempt to target advertising to particular groups of consumers by tailoring the advertising campaign media, the frequency of the campaign, the nature of the advertisements, the geographic location of the campaign, and many other variables.

Smaller businesses (e.g., a local business) often have limited budgets with which to target potential customers. A national or regional advertisement may cover a geographic area that includes consumers unlikely to be potential customers of the local business with the local business paying for more coverage than needed. It would be desirable for a local business to be able to pay for and target a relatively small geographic area during specified time frames in order to maximize the likelihood that the advertisement reaches a high concentration of potential customers. In addition, it would be desirable for the advertising campaign content to be updatable in a real-time manner in response to a request for a change by the local business. Thus, the local business would be able to highlight impromptu sales and/or services based on, for example, on excess inventory, sporting events, and weather conditions. These same features discussed above would also be desirable to a national business in reaching local markets.

### BRIEF SUMMARY OF THE INVENTION

An exemplary embodiment is a system for providing a real-time content distribution network. The system includes a player device at a host location. The player device includes a network interface for communicating with a content provider server device via a network, one or more speakers, and a computer processor in communication with the network interface and the one or more speakers. The computer processor includes instructions for facilitating receiving a playlist from the content provider server device, the playlist specifying one or more audio media files including audio content and attributes, the attributes including a content type and play instructions, and the receiving in response to a request from the player device for an updated playlist. The instructions further facilitate accessing the audio media files specified by the playlist. In addition a play queue including all or a subset of the audio content included in the audio media files is built, with the building being responsive to local play sequence rules and to the attributes. Further, the audio content of the play queue is broadcast at the one or more speakers.

A further exemplary embodiment includes a system for providing a real-time content distribution network. The system includes a content provider server device including a computer storage device for storing playlists and audio media files. The playlists include a list of audio media files that have audio content and attributes. The attributes include a content type and play instructions. The system also includes a network interface for communicating with a plurality of player devices at host locations. Each of the host locations includes a single player device identified by a media access control (MAC) address. The system further includes a computer processor in communication with the computer storage device and the network interface. The computer processor includes instructions for facilitating receiving an audio content and a play instruction from a client. The play instruction specifies one or more of the host locations. The audio content is approved by a content manager via a user device. An audio media file is generated from the approved audio content and the play instruction. The audio media file is stored in the computer storage device. A request for updated information is received from one of the host locations specified in the play instruction. The audio media file is transmitted to the requesting host location via the network interface. In addition, broadcast time reporting data is received from the host locations on a periodic basis via the network interface.

A further exemplary embodiment includes a method for providing a content distribution computer network. The method includes transmitting a playlist specifying one or more audio media files and host locations to one or more player devices at the host locations. The transmitting is in response to a request from the one or more player devices for an updated playlist. The audio media files include audio content and attributes, and the attributes include a content type and play instructions. Each of the player devices are located at a different host location and are identified by a MAC address. The playlist and audio media files are utilized by the player device along with local play sequence rules to build a play queue for broadcast at the host location. One of the audio media files is transmitted to one of the player devices in response to a request from the player device for the audio media file. An audio media file including music audio content from an independent musician client is created. The creating includes: receiving the music audio content, approving the music audio content, editing the approved music audio content to include data about the musician, generating a new audio media file from the edited approved music audio content, adding the new audio media file to the playlist, and transmitting the playlist and the new audio media file to one or more of the player devices in response to the musician selecting the host locations associated with the player devices and to a request from the player devices for the new audio media file. Broadcast time reporting data for the audio media files in the playlist is received on a periodic basis. The broadcast time reporting data is transmitted to clients associated with the audio media files in the playlist. An alert is generated for a player device in response to not receiving the broadcast reporting data within the periodic basis, the alert indicates that the player device may not be operational.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 depicts a block diagram of an exemplary system for providing a real-time content distribution network;

FIG. 2 depicts a process flow that may be implemented by an exemplary embodiment of the content management software to set up an advertisement and/or account;

FIG. 3 depicts a process flow that may be implemented by an exemplary embodiment to set up a player device at a host location;

FIG. 4 depicts a process flow that may be implemented by a player device at a host location in accordance with an exemplary embodiment; and

FIG. 5 depicts a trouble-shooting process flow that may be implemented by an exemplary embodiment.

### DETAILED DESCRIPTION

Exemplary embodiments include a real-time content distribution network that manages content in real-time by utilizing the Internet to update and to distribute audio media files. The content distribution network is created of individual host locations including, but not limited to: high volume gasoline stations, retail outlets, and music venues. Each network host at an individual location has the ability to be treated as an independent “radio station” but also to be linked to the entire network or a set of user-defined locations (referred to herein as “customized groups”). The programming content may include, but is not limited to: comedy, trivia, news, weather, entertainment facts, music (e.g., from independent musicians), local advertising, regional advertising, and national advertising.

In an exemplary embodiment, the content distribution network provides a music platform where independent musicians have an outlet to market their music. The musicians submit (e.g., via a website) their songs to be played on the content distribution network. A content manager, working for or on behalf of the content provider then reviews the songs for content. If a song is accepted for play, the song will be edited to a standard length and tagged at the beginning and end of the song to encourage listeners to log on to the musician's website (or some other location) to learn more about the musician and/or to purchase recordings of the music. In an exemplary embodiment, the musicians use the Internet to fill out a credit card authorization form with an electronic signature page and once the song has been approved for play, the credit card is billed by the content provider. The song is played at the host location with an approximate frequency and/or time as agreed to by the musician and the content provider. In addition, a musician may be provided a hyperlink from the content provider website to the musician's website.

An example implementation of a content distribution network includes a host location at a gasoline station with self-service gasoline pumps. The gasoline station has a player device for connecting to a content provider server device and for executing software for playing the advertising and/or other content. In addition, the player device has a wireless or wired connection to send audio output to speakers at the gasoline pump. Advertising and/or other content to be included in the play sequence at the host location is received from the content provider server and stored in the player device at the host location (the gasoline station in this example). In an exemplary embodiment, the content is received from the content provider in an audio media file encoded in an extensible markup language (XML) format that also includes attributes about the content such as the type of content and parameters about when to play each spot.

In the above example, the content may include, among other things, an advertisement for a business, such as a dry-cleaning store located across the street from the gasoline station. The dry-cleaner could run an advertising spot stating its location relative to the gasoline station and could offer a discount to customers who bring a receipt from the gasoline station. In this manner, the dry-cleaner can track how many customers it is bringing in from the advertisement at the gasoline station. In addition, the dry-cleaner could detect that it currently has unused capacity in its shirt-cleaning operation and could request the content provider to change the advertisement to offer a discount for shirts only. In an exemplary embodiment, the dry cleaner would contact the content manager at the content distribution network and request the change. The content manager would rework the advertisement to incorporate the change. The dry cleaner would be sent the new audio for review. Upon approval, the new audio would be launched into the content distribution network, replacing the old content. In this manner, the dry-cleaner can request real-time changes to its advertising based on current business conditions. The dry-cleaner will pay a fee for its advertising spots to run a selected number of times, and as described below at approximate time(s) and location(s). To verify that the advertisements have been run, the dry-cleaner receives a broadcast time report of run times/locations and/or has access to a report module via email or Internet access specifying when the advertisement actually ran and at what location(s).

In the above example, the content may also include music by an independent musician, with the musician paying for a set number of plays at particular locations. If the music is rock music and the gasoline stations is near a music venue that plays rock music, the musician may request that the song be played before and after rock bands are scheduled to perform at the music venue. In this manner, the musician can select a target audience that will include likely customers. Also, the playlist at the gasoline station may be over-ridden by information from warning system content such as, but not limited to: a weather alert, a traffic alert, and/or an Amber alert. If the system at the gasoline station experiences system faults, selected parties are notified. System support personnel may be notified via user devices (e.g., cellular telephones and personal digital assistants) so that troubleshooting can begin in an expeditious manner.

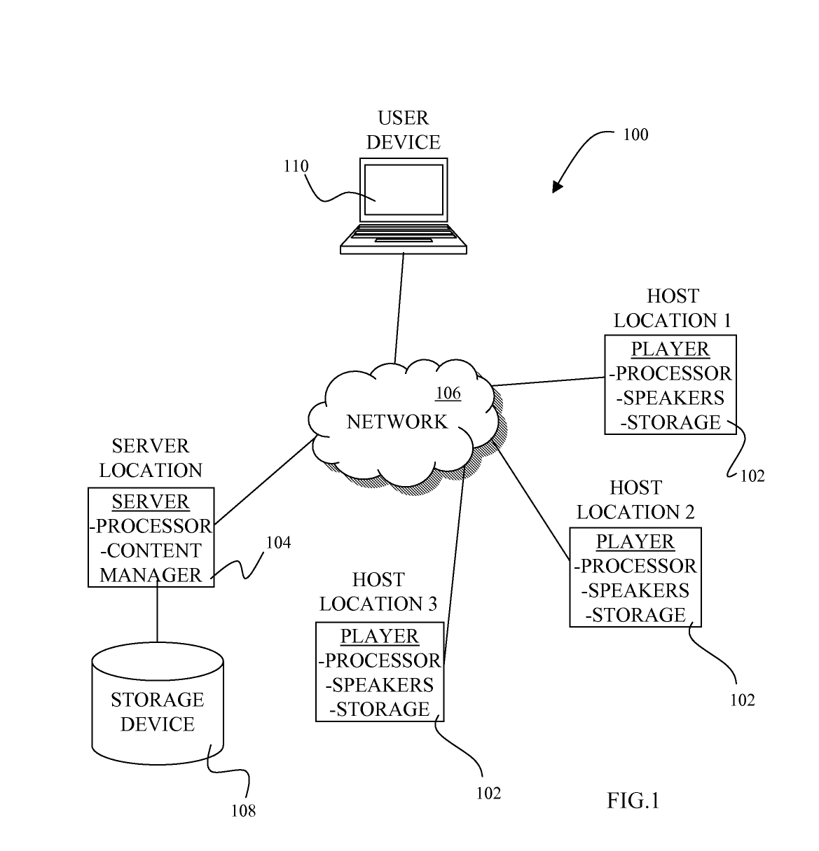

FIG. 1 depicts a block diagram of an exemplary system for providing a real-time content distribution network 100. The system includes hardware, software, network locations, programming, music content, entertainment content, and information content. Each of the host locations include a player device 102 with a network interface, a computer processor, speakers (or a connection to a speaker), and a storage element (e.g., a hard drive on the player device 102 or access to a storage device). In an exemplary embodiment, the player device 102 is implemented by a player device 102 with an amplifier (e.g., an Inter-M-70 volt amplifier), one or more outdoor speakers (e.g., Quam outdoor speakers), a hard drive, and an Internet modem or router or other network interface for connection to the network 106. In an exemplary embodiment, the player device 102 located at the host location does not include a user interface (e.g., a display or keyboard) and the player device 102 is updated (e.g., configuration data, computer programs) by instructions received via the network 104. The Internet modem may be implemented by a digital subscriber lines (DSL) modem, a cable modem, wireless broadband and/or any other manner known in the art for providing connection to the network 106. The player device 102 also includes computer instructions to perform the host location processing described herein.

In an exemplary embodiment, the player device 102 is equipped with wireless broadband connection to the network 106. Using the wireless broadband connection eliminates the need for a host location to have an existing network connection for use by the player device 102 to connect to the network 106 to access a server device 104. This allows the player device 102 to be installed and operated independently of existing computer equipment and software at the host location. In this example, the player device 102 is configured by the content manager provider and shipped to a host location ready to be utilized to provide the functions described herein. Thus, the player device 102 can be “plug and play” in that it can be plugged in at the host location and ready to be utilized to provide the functions described herein.

The player device 102 repeatedly checks server device 104 for a new XML playlist and downloads new content (e.g., an audio media file that specifies the individual player device 102) that is stored locally by the player device 102. The content and associated data may be stored in a database format, and include information such as control data, played data, playlist data, queue data, server data and volume adjust data. In an exemplary embodiment, the control data includes data related to the player device 102 such as a time stamp, a start time, an end time, a total time, an XML serial number, a concurrent versions system (CVS) version, a CVS script uniform resource locator (URL), a CVS script check, a reboot indicator, a reboot identifier, a reboot time, a current volume and a play order. In an exemplary embodiment, the played data includes data related to content that has been played at the player device 102 and includes a unique track identifier, a track start time and date, a track end time and date, and a track type. This played data is used to generate reports and/or bills for clients.

In an exemplary embodiment, the playlist data includes data related to audio media files (or “tracks”) in a playlist on the player device 102 and includes data such as a customer identifier, a unique track identifier, a track type, a track start time, a track validity date and time, a minimum number of plays, a maximum number of plays, a track priority, a track location, a track check, and a track category. Data such as last played, play count, hour count, local copy indicator and a queued indicator are determined at the player level in real time and factor in to the creation of the play queue on the player device 102. In an exemplary embodiment, the queue data includes information about what tracks have been queued for play at the host location such as the name of the queue (or play sequence), the track identifier and the customer identifier. In an exemplary embodiment, the servers data includes information about the server device that the player device 102 is in communication with and the volume adjust data includes data about the speaker volume and when the speaker volume was last adjusted.

Storing the content at the player device 102 provides another layer of system redundancy by allowing the player devices 102 to continue to operate even if the back-end server device 104 is not operational. In addition, in the event of a storage device 108 failure, the content of all or a portion of each of the player device storage elements may be copied into the storage device(s) 108 utilized by the server device 104. When a host location loses Internet connectivity or power, the server device 104 detects (or is notified of) this condition. In response to detecting this condition (or other error conditions), the server device 104 sends e-mail alerts to selected user devices 110 (e.g., computer maintenance personnel devices) to inform them of the malfunction and/or to initiate troubleshooting to correct the error condition. The user devices 110 may be implemented by any device capable of communicating with the network 106 such as, but not limited to: a personal computer, a personal digital assistant, or a cellular telephone. In an exemplary embodiment, a user device 110 is utilized to communicate with the content management software on the server device 104 (e.g., to set up a new client account, to approve advertising segment content, etc.).

The server device 104 includes a computer processor with content management software that directs the operation of the player devices 102. The content management software allows the content distribution network to operate in real-time as well as to generate reports in real-time. The content management software allows clients (e.g., via player devices 102 at host locations) to air the same message at several host locations or to air completely different messages at the several host locations. This allows a regional or national company to maintain consistency with its messages but allows each message to be localized (e.g., tag the message with local store information) by zip code or any other criteria.

The server device 104 depicted in FIG. 1 may be implemented using one or more servers operating in response to a computer program stored in a storage medium accessible by the server. The server device 104 may operate as a network server (e.g., a web server) to communicate with the player devices 102 and the user devices 110. The server device 104 handles sending and receiving information to and from the player devices 102 and the user devices 110 and can perform associated tasks. The server device 104 may also include a firewall to prevent unauthorized access to the server device 104 and enforce any limitations on authorized access. A firewall may be implemented using conventional hardware and/or software as is known in the art.

The server device 104 may also operate as an application server. The server device 104 executes one or more computer programs to implement the real-time content distribution network functions described herein. Processing may be shared by one or more of the player devices 102 and the user devices 110 and the server device 104 by providing an application (e.g., java applet) to the player devices 102 and the user devices 110.

Alternatively, the player devices 102 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

Host locations (also referred to herein as network locations) refer to any venue where a number of people are located for a period of time. Examples of host locations include gas stations and concert venues. In an exemplary embodiment, each host location provides and pays for the Internet connectivity and electricity to operate the player devices 102. In an alternate exemplary embodiment, a wireless broadband connection is provided in the player device 102 and the cost of the connection is taken from the shared advertising revenues. In addition, the host location pays for the electricity to operate the player device 102. Each host location may be allotted air time each hour to promote their business and the company providing the content distribution network may be allotted air time each hour to promote the content provider business. Revenue arrangements are determined between the content manager provider and the host locations. For example, each host location may receive a percentage of the net advertising revenue collected per month (e.g., once the content provider is paid for the advertising, the host location receives thirty percent the following month). This is referred to herein as “revenue sharing.” In an exemplary embodiment, the content providers install the content distribution network in geographical clusters based on traffic patterns and volumes.

Each host location includes a player device 102 that includes software executing on the processor to respond to playlist content (e.g., contained in the playlist data) received by the server device 104 and to adjust its individual play sequence. Each player device 102 has the ability to be programmed independently of other player devices 102. In an exemplary embodiment, the play sequence is six minutes long and can be modified to any length and content. In an exemplary embodiment, the standard play sequence is “BMSSS” where “B” is a bumper that contains comedy, trivia, news and alerts, “M” is the music, and “S” is the commercial segment. In an exemplary embodiment, the content provider provides a minimum of thirty commercial segments per hour per location. In alternate exemplary embodiments, the programming pods are configured differently (e.g., “BSBSM”), the play sequences are of different lengths, and/or the segments are of different lengths. In this manner, the content provider can provide great flexibility in the content provided at each host location. By controlling the length of each audio file, a virtual time clock is created. Thus, host locations 1 and 2 may have identical play sequences while host location 3 and host location 2 may have a different play sequence, with all three play sequences based on instructions from the content provider via the server device 104.

As depicted in FIG. 1, the server device 104 located at the server location and the player devices 102 located at the host locations are interconnected via a network 106. The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation. A player device 102 and/or user device 110 may be coupled to the server device 104 through multiple networks (e.g., intranet and Internet) so that not all user systems 102 are coupled to the host system 104 through the same network. One or more of the player devices 102, the user devices 110 and the server device 104 may be connected to the network 106 in a wireless fashion.

The storage device 108 includes audio media files including content, playlist data, customer account data, and other data related to the real-time content distribution network functions. In an exemplary embodiment, the data in the storage device 108 is stored in a database format. The storage device 108 may be implemented using a variety of devices for storing electronic information. It is understood that the storage device 108 may be implemented using memory contained in the server device 104 or it may be a separate physical device. The storage device 108 is logically addressable as a consolidated data source across a distributed environment that includes the network 106. Information stored in the storage device 108 may be retrieved and manipulated via the server device 104 and/or via one or more user devices 110 and player devices 102. In exemplary embodiments of the present invention, the server device 104 operates as a database server and coordinates access to application data including data stored on the storage device 108. In the embodiment depicted in FIG. 1, the storage device 108 is directly connected to the server device 108. In an alternate exemplary embodiment, the storage device 108 is connected to the network 106 and is accessed by the server device 108 via the network 106.

In an exemplary embodiment, the server device 104 is comprised of redundant servers (e.g., Linux servers) with internal storage (e.g., the storage device 108 is internal to the server device 104) and runs Gentoo Linux. In an exemplary embodiment, the processing at the server device 104 is implemented by code written in PHP: Hypertext Preprocessor (PHP) using a MySQL database.

In an exemplary embodiment, the player device 102 is implemented by a small form factor personal computer, utilizing Gentoo Linux. Small form factor personal computers that may be implemented by exemplary embodiments include, but are not limited to an embedded device and/or a fanless device. In an exemplary embodiment, the processing at the player device 102 is performed by code written in Perl using a MySQL database.

The content provider may use locally produced content and/or packaged content from other media outlets. In an exemplary embodiment, various locally produced comedy and trivia vignettes are rotated into the play sequences at the host locations randomly to help make the programming at the host locations (e.g., gasoline station, concert venue) more entertaining. In addition, the content provider can insert information from various warning systems (e.g., Amber alert system, weather alert system) into the play sequences at selected host locations. Thus, real-time information is provided to customers at the host locations.

As described previously, in an exemplary embodiment, the standard play sequence is “BMSSS” where “B” is a bumper that contains comedy, trivia, news and alerts; “M” is a music segment; and “S” is a commercial segment. A master copy of each segment (also referred to herein as a “track” or “audio media file”) is stored in the storage device 108 at the server location. The bumper segments typically contain entertainment content including, but not limited to, comedy, trivia and facts. The type of entertainment content is stored as an attribute of the entertainment content. The music segments include songs that have been categorized as particular genres and stored in genre libraries. The genre libraries may be assigned to individual locations or groups based on the major demographics of clients. The music genre is stored as an attribute of the music content. The commercial segments may include third party network advertisements as well as local advertisements.

The standard play sequence can be interrupted by alerts (e.g., warning system data) which are designed to allow for quick and efficient upload of important and time sensitive audio information. Examples of alert information include, but are not limited to: Amber alerts, weather alerts, and emergency information alerts. In an exemplary embodiment, the alert audio plays after a set number of audio spots for a set period of time, with the setting being programmed at the time of upload in the player device 102. The alert settings trump all other location playlist sequences for the duration of the alert.

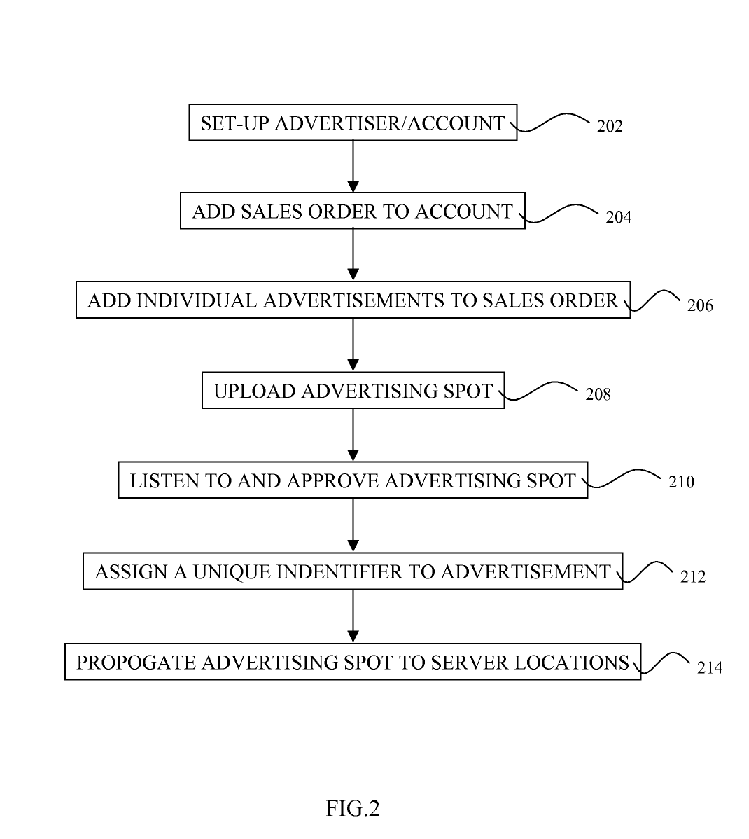

FIG. 2 depicts a process flow that may be implemented by an exemplary embodiment of the content management software to create a new advertising spot (for a new or existing client account). In an exemplary embodiment, this software is located on the server device 104 and accessed by a user device 110. At block 202, an account is set up in the content manager system with contact information and a billing address. In an exemplary embodiment, setting up the account includes: assigning the account to a salesperson for tracking of commissions and task assignment queues; assigning account contacts/users with user ID and passwords for the client user reporting interface and client account audio spot drop-in; and assigning the account to an agency (if applicable) for tracking of agency discounts and providing the agency with the client user reporting interface. At block 204, the sales order is added to the account, including defining the sales order start and end dates and assigning the location(s) to receive the advertisement in the sales order. The location(s) may include individual locations, or location groups (e.g., full network, Hartford County, all Mobil gasoline stations, etc.).

At block 206, the individual advertisement is added to the sales order. The advertisement type is set to standard, fixed, recurring fixed, weighted rotating, and third party network advertisements. A standard advertisement is one where the advertisement plays randomly in the play sequence throughout the hour based on the following rules: 1. priority—setting of 1-5 with 5 being the highest; 2. minimum plays per hour; and 3. category—spots from same category should not play back-to-back. A fixed advertisement plays as close as possible to a specified time during the hour (based on factors such as network or Internet availability and/or uptime) despite the play sequence setting. As used herein the term “play sequence setting” refers to the play sequence. A recurring fixed advertisement recurs at set intervals during a set period of time despite the play sequence setting. For example, a recurring fixed advertisement may occur every fifteen minutes from ten in the morning until two in the afternoon for as long as the flight dates allow. A weighted rotating advertisement refers to multiple advertisements for one advertiser that are rotated based on percentage settings within any of the above advertisement types. Third party network advertisements are those spots that are reserved for advertising spots from third party networks.

Still referring to block 206, adding the individual advertisement also includes adding the flight dates (e.g., settings by date and time of day within the start/end dates of the sales order) and setting the spot rate for billing purposes. As used herein the term “flight dates” refers to parameters authorizing the periods of time that commercials can air such as time of day and week.

At block 208, the advertising spot along with spot attributes is uploaded to the storage device 108 at the server device 104 as an audio media file. In an exemplary embodiment, a system trafficker uses a browser to find an MP3 file. For clients that have the capability of uploading their own advertising spots, the system trafficker sets parameters and attributes for those spots uploaded by the client. In an exemplary embodiment, the client uploads a new spot to the server device 104 as system content changes. In addition, the content manager software on the server device 104 checks for proper format, and for a recognized client user identifier and password. Reports of client drop in spots are generated on a daily basis and made available to the client and to the content manager/provider.

In an exemplary embodiment, once the account is set up, the client is given access to portions of the content management software to perform all or portions of the process described in reference to blocks 204, 206 and 208. For example, the client may view a list of host locations where the content distribution network is available and be able to select host locations for his/her content to be played. In addition, the client may upload content for review and addition to the playlist (pending content manager approval if it has not already been approved). Further, the client may change the content of his/her own spots to take effect the next time the playlist is updated at the host location (again, pending content manager approval of the spot if it has not already been approved).

At block 210, a representative of the content manager, using a user device 110, listens to and approves the spot (e.g., via a pop-up window and inputting initials for approval). Upon approval, block 212 is performed and the advertisement is assigned a unique identifier by the content management software. At block 214, the advertising spot, along with its attributes (e.g., advertisement type and flight dates) is propagated, via the network 106, to the designated locations. In an exemplary embodiment, the advertising spot is added to the XML playlist(s) on the specified player device(s) 102. Software on each of the player devices 102 is utilized to determine the order of the individual play sequences based on the attributes associated with the advertising spots assigned to the individual player devices 102.

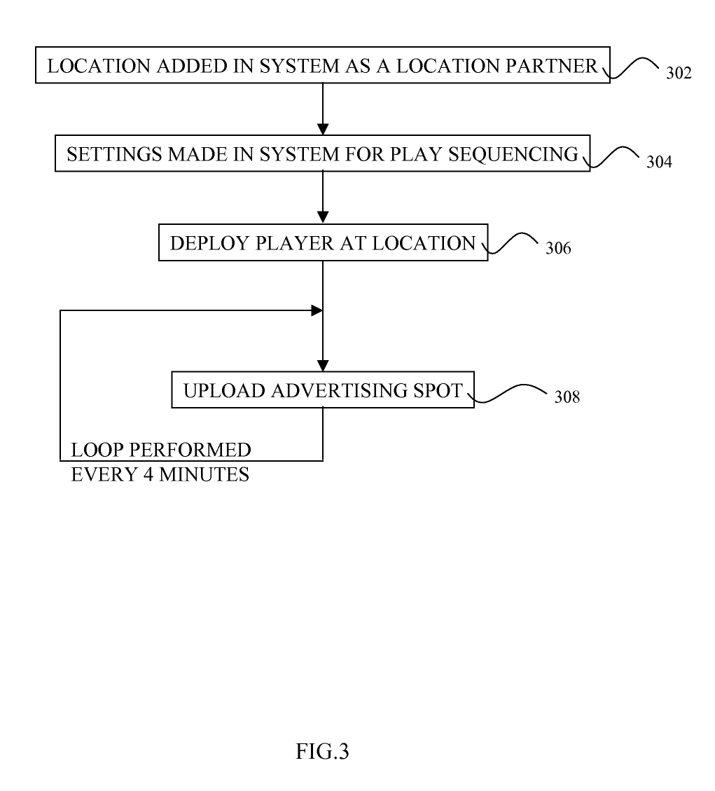

FIG. 3 depicts a process flow that may be implemented by an exemplary embodiment to set up a player device 102 at a host location. At block 302, a location is added into the content distribution network (e.g., stored in the storage device 108) as a location partner. Each host location is independent and may be unique in the audio plays, essentially acting as a stand-alone radio station. Location information includes: host location share percentage for revenue share reporting; media access control (MAC) address (a unique hardware identifier that allows the content manager software to communicate specifically with the given player device 102); on/off times (based upon host location hours of operation, player never really powers “off” but instead stops playing content while continuing to check for changes in the XML). In an exemplary embodiment, percentage of full volume adjustments are set based on time of day for the individual needs of the host location (i.e., louder during rush hours, quieter during overnight). In addition, over ten different settings and volume changes can be made and based on these settings, the player device 102 controls the volume of the audio pushed out to the amplifier and therefore, to the speakers.

At block 304, additional settings are made in the player device 102 for play sequencing and easy propagation of advertisements and content to the locations. As used herein, the term “customized groups” refers to locations that are assigned to groups to aid in propagation from sales orders and assignment of other audio types. Each host location is assigned a sequence from which to play a specific type of audio. This allows for control of the amount of inventory; optimizes the overall sound of the product (i.e. locations with less advertisers will play more music and other audio content to avoid annoying repetition of ads). A set number of positions are available (e.g., 1-8, 1-12). The term “play sequence” refers to patterns of audio types or audio lengths, in this example from 1 to 12 positions (e.g., BSMSSMSSSBMSS). There is no upper limit on the total number of position in a play sequence.

At block 306, the player device 102 is deployed at the host location including setting up the speakers (including amplifiers if needed). Each host location may have a unique configuration and placement (when compared to other host locations) based on optimal sound quality and existing wiring at the host location. In an exemplary embodiment, the player device 102 is connected to the amplifier, to the Internet, and to a power source. At block 308, the player device 102 connects to the Internet and downloads a new XML playlist, if a new playlist is available. To determine if new XML is available, the player device 102 checks a serial number of the current playlist on the player device in XML. If serial number does not match serial number in the control table, then the player device 102 downloads a new XML playlist. The player device 102 connects to a URL on the server device 104 that corresponds to the host location. The content manager recognizes the player device 102 by its MAC address. The player device 102 retrieves the media files from the storage device 108 at the server location and builds an internal playlist (e.g., as a queue). The player device 102 executes software to determine which audio to play in which order based upon the play sequence, type of audio and the advertisement settings programmed within sales order and spot upload. This is referred to herein as “building a play queue.”

As depicted in FIG. 3, the software on the player device 102 repeats step 308 every four minutes (or some other selected time interval). The selected time interval may be programmatically modified based on criteria such as time of day, day of the week, etc. Checking for updates on a periodic basis allows for real time changes to be made at each individual host location. A command from the host location and/or the server location can also force a new XML download. The command from the server location can force a new XML download to the whole network or to individual host locations at any time from the content manager system. The new XML download can include the whole playlist for the player device 102 or just an update to the playlist (e.g., a single spot, or some other subset of the whole playlist).

If new XML is available, the XML is downloaded and the database and the playlist are refreshed. The player device 102 then checks to determine if the files (e.g., the audio media files) listed in the XML are on the local player device 102. If they are not located on the local player device, then the player device 102 starts downloading the files it needs. The player device 102 creates a play queue based on play sequence and existing rules (the rules may be modified/broken if no queue can be created). As the player device 102 plays something from the queue, it checks the play sequence and rules again to add another media file to the queue. After playing the selection from the queue, the player device 102 reports back to the server device 104 to track the start and stop times. In an exemplary embodiment, the player device 102 reports back to the server system on a periodic basis (e.g., every five minutes, every ten minutes, etc.) and, not after every track has played on the player device 102. This periodic basis may be modified based on client requirements. The server device 104 checks the reporting table for any player devices 102 that have not reported within the last specified time frame and sends out a notification to designated recipients (e.g., at a user device 110). In this manner, the server device 104 can monitor the status of all player devices 102 in the content distribution network.

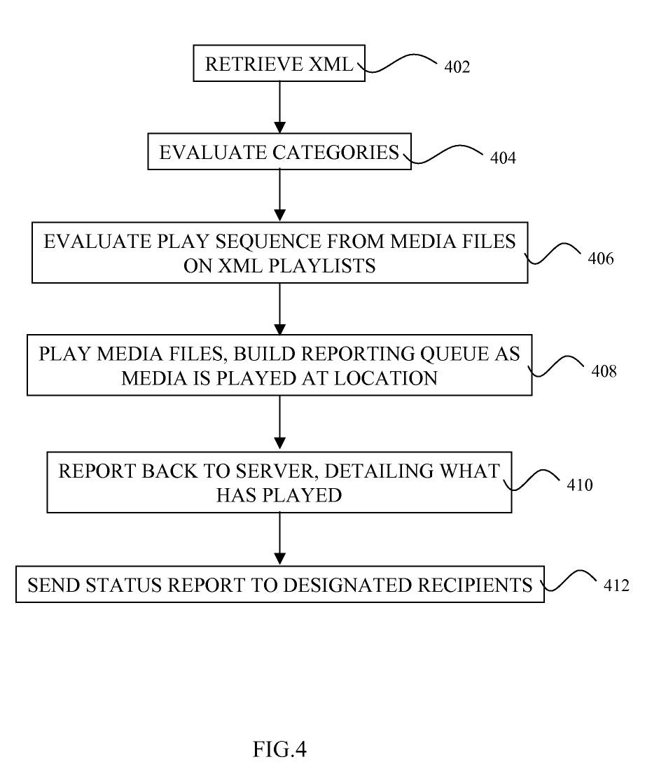

FIG. 4 depicts a process flow that may be implemented by an exemplary embodiment of software instructions located on a player device 102 at a host location. At block 402, software located on the player device 102 retrieves the XML that includes the spot information (e.g., the audio media files). At block 404, the categories in the XML are evaluated to avoid playing the same categories back to back. At block 406, the player device 102 evaluates a play sequence based on the content of the media files. At block 408, the media files are played and a reporting queue is built and stored on the player device 102 to record the spots that are actually played. At block 410, the player device 102 reports back to the content manager, detailing what has just played at the player device 102. In an exemplary embodiment, the player device 102 performs step 410 every four minutes (or some other user defined time interval). If the Internet connectivity to the server device 104 is lost, then the reporting is queued and reporting to the server device 104 resumes when Internet connection resumes.

At block 412, a status report is sent from the server device 104 to a designated recipient(s) at a user device(s) 110. In an exemplary embodiment, the status report indicates that all of the host locations are reporting properly or that issues are found. If issues are found then the status report lists any locations not reporting and the time of the last report.

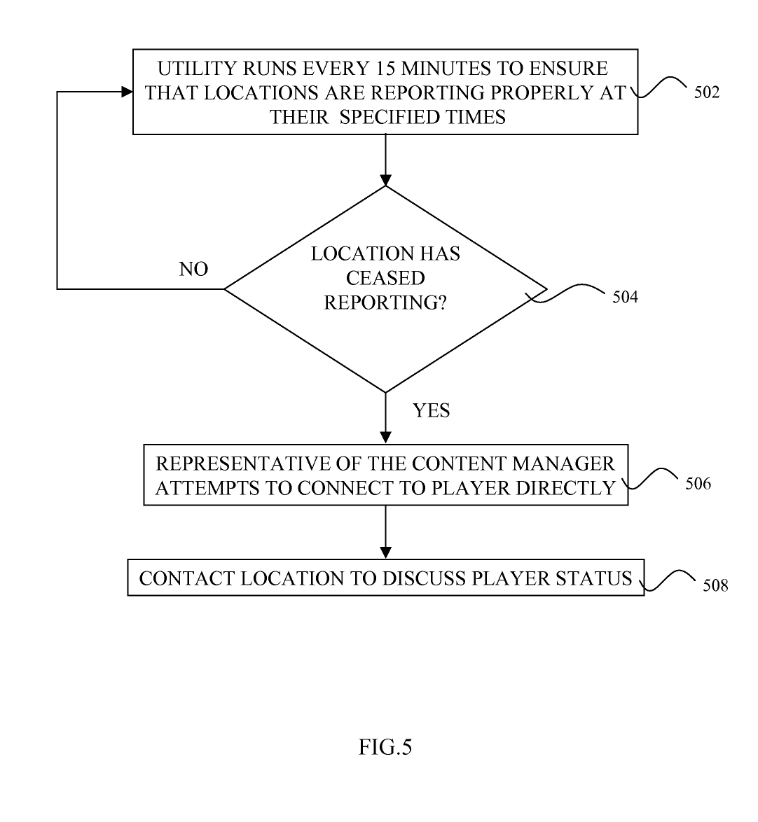

FIG. 5 is an exemplary trouble shooting process flow that may be implemented. At block 502, a utility is executed on the server device 104 every fifteen minutes (or some other selected time interval) to ensure locations are reporting properly at their specified times. At block 504, the server device 104 checks a reporting table for any player devices 102 that have not reported within the specified time frame.

If it is determined, at block 504, that a host location has ceased reporting in the last fifteen minute time period, then block 506 is performed and the representative of the content manager attempts to connected to the player device 102 directly. In an exemplary embodiment, a server-side script catalogs the last known IP address of each player device 102 in the radio network. Using this IP address, the representative of the content manager 104 attempts to connect to the player device 102 remotely directly via SSH using command-line Linux/Apache commands. If the player device 102 is accessible, troubleshooting continues, including checking database, forcing XML downloads, etc. In an exemplary embodiment, block 506 also includes sending a notification to one or more designated recipients (e.g., at a user device 110) to notify them that the location has ceased reporting.

If the player device 102 is not accessible, then block 508 is performed and the location is contacted to determine the player device 102 and Internet status. In an alternate embodiment, block 508 is performed to contact an individual at the host location regardless of the success in connecting at block 506. At block 508, it is determined if there is something playing through the speakers at the host location. In addition, the individual is questioned to determine if their Internet connection has been unplugged on purpose or if there is a larger problem with the Internet connectivity. The status of the player device 102 and the Internet connection determine the next troubleshooting procedure. If an individual at a host location calls an individual working for the content manager provider complaining that an advertisement or song is repeating or playing static, then the individual working for the content manager provider logs on to the server device 104 and regenerates the XML playlist for the player device 102 at the given host location. The server device 104 can force the player device 102 to cease playing, and can reboot the player device 102, forcing the download of a new XML playlist.

An exemplary embodiment, allows for the creation of a new advertising type that allows for interface with another (e.g., a third party) advertising service. The amount of inventory allotted to the third party advertising service is controlled by the play sequence at each individual location. The third party network will communicate with the server device 104, delivering code (e.g., XML files) containing rules and other information regarding audio to be played. The content manager software at the server device 104 propagates spots to appropriate playlists and host location XMLs. The player device 102 then reports back the times that the advertising spot plays to the third party network.

In an exemplary embodiment, reporting is performed by having the player device 102 queue all media that has been played by the player device 102 and reporting this information to the server device 104. Reports can be viewed right from the server device 104 and/or imported into Excel.

Examples of broadcast time reports include, but are not limited to: the last 50 spots played (shows snapshot of last 50 audio spots including start and stop times); monthly by location (shows monthly snapshot based on user choices by location); daily by location (shows snapshot of the number of times specific advertisements and bumpers played at each location on a given day; current day updates in real time); hourly by location (shows snapshot of number of times specific advertisement and other audio content played at each location in any given hour, current hour updates in real time, and the ability to drill further into detail including sequence of audio and start and stop times); client reports (using a separate interface in the content manager software, clients can log in to view the details of when and where their advertisements played in similar format to the monthly, daily and hourly by location reports); and agency reports (using a separate interface in the content manager software, agencies can log in to view the details of when and where their clients' advertisements played in similar format to the monthly, daily and hourly by location reports). All of these reports can be utilized to generate affidavits of performance.

Other reports include content management reports such as an expiring spots report, a missed minimum plays report and a missing spots report. In an exemplary embodiment, the expiring spots report shows list of advertisements by account that are set to expire within a set number of days before or after user defined date. An account salesperson is alerted when a client's spot is about to expire. In an exemplary embodiment, the missed minimum plays report provides a list of spots that did not meet their minimum plays during a given hour at a given location due to lack of available inventory. To remedy this situation, the traffic manager (e.g., a “super user”) changes the host location playlist to increase inventory, or the player device 102 automatically changes the host location play sequence to increase inventory. In an exemplary embodiment, the missing spots report alerts a salesperson and a system trafficker that a spot due to start airing has not been uploaded.

In an exemplary embodiment, the content management software generates invoices and statements. The storage device 108 includes a database containing account, sales order and spot data to automatically create invoices for the clients. Different types of invoices include: monthly and partial month pre-paid; monthly and partial month in arrears; and per play. In addition, the content manager software tracks commissions. Commissions paid on collected revenue for advertising completed (monthly) can be determined and future commissions reports for each salesperson can also be generated. In exemplary embodiments, an accounting interface is provided to import and export data through an interface with an existing accounting software such as Quickbooks.

An exemplary embodiment includes a music distribution model. An artist account is created, either by a representative of the content manager or by the artist via a form from a web site supported by the content manager software. Next, an indemnity letter and agreement are signed by the artist electronically or physically. The song file is then submitted by the artist including: the lyrics; the audio file; the genre chosen; an artist URL; a number of plays chosen (minimum 100 or some other pre-selected number); and credit card number (information captured only; card is not charged until submission is deemed acceptable). The song file is uploaded to the server device 104 when the form is submitted. The content manager receives notification of submission via e-mail or through monitoring of a database. A representative of the content manager logs on to the content manger software and views the submission details, listens to the track; reads the lyrics (looking for unacceptable content); and approves the track. Upon approval, the content manager production team adds overlay to the beginning and the end of the track, advertising the track name and the artist prior to the song beginning and/or after the song ends, and where to find the artist (e.g., artist URL or other designated URL following the track playing).

Upon approval, the content manager “approves” the song for distribution into its system. Based upon song genre, it is propagated to the playlist of each player device 102 that plays the specified genre at its location. Upon completion of the number of plays or period of time the artist has prepaid for, the song falls out of rotation at host locations (i.e., it is automatically removed from all playlists) and the artist is sent an e-mail automatically asking them to login and visit a unique URL in the content manager system to “reload” (i.e., purchase more plays). The prices per play may be dependant upon volume of plays purchased, on a sliding scale.

Exemplary embodiments, as described herein provide targeted advertising and real-time updates to the advertising segments, thus technical effects and benefits include providing a targeted and relatively low cost advertising channel.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A player device at a host location, the player device comprising:
a network interface for communicating with a content provider server device via a network;
one or more speakers; and
a computer processor in communication with the network interface and the one or more speakers, the computer processor including instructions for facilitating:
receiving a playlist from the content provider server device, the playlist specifying one or more audio media files including audio content and attributes, the attributes including a content type and play instructions, and the receiving in response to a request from the player device for an updated playlist;
accessing the audio media files specified by the playlist;
building a play queue including all or a subset of the audio content included in the audio media files, the building responsive to local play sequence rules and to the attributes; and
broadcasting the audio content of the play queue at the one or more speakers.

2. The player device of claim 1 further comprising a storage element for storing one or more of the playlist, the audio media files and the play queue.

3. The player device of claim 1 wherein the content types include music, commercial, alert and bumper and the local play sequence rules specify an order of play for the different content types.

4. The player device of claim 1 wherein the play instructions specify one or more of approximate times and dates for broadcasting.

5. The player device of claim 1 wherein the play instructions specify frequencies and dates for broadcasting.

6. The player device of claim 1 wherein the player device periodically transmits reporting data about the audio content of the play queue broadcast by the speakers, the reporting data including times and dates of broadcast.

7. The player device of claim 1 wherein the accessing includes requesting one or more of the audio media files from the content provider server and receiving the requested one or more audio media files from the content provider server.

8. The player device of claim 1 wherein the host location includes a single player device.

9. The player device of claim 1 wherein the player device is installed and operated independently of existing hardware and software at the host location.

10. The player device of claim 1 wherein the speaker is located at an outside location at the host location.

11. A content provider server device comprising:
a computer storage device for storing playlists and audio media files, the playlists including a list of audio media files, the audio media files including audio content and attributes, and the attributes including a content type and play instructions.
a network interface for communicating with a plurality of player devices at host locations, each of the host locations including a single player device identified by a media access control (MAC) address; and
a computer processor in communication with the computer storage device and the network interface, the computer processor including instructions for facilitating:
receiving an audio content and a play instruction from a client, the play instruction specifying one or more of the host locations;
approving the audio content, the approving performed by a content manager via a user device;
generating an audio media file from the approved audio content and the play instruction;
storing the audio media file in the computer storage device;
receiving a request for updated information from one of the host locations specified in the play instruction, the receiving a request for the updated information via the network interface;
transmitting the audio media file to the requesting host location via the network interface; and
receiving broadcast time reporting data from the one or more host locations on a periodic basis via the network interface.

12. The content provider server device of claim 11 wherein the instructions further facilitate generating an updated playlist including the generated audio media file, storing the updated playlist in the computer storage device, and transmitting the updated playlist to the host locations specified by the play instruction in response to receiving the request for updated information.

13. The content provider server device of claim 11 wherein the audio content is music from an independent musician.

14. The content provider server device of claim 11 wherein the audio content is an advertisement.

15. The content provider server device of claim 11 wherein the audio content is warning information and the audio media file is transmitted to the one or more host locations included in the play instruction is response to receiving the audio media file.

16. The content provider server device of claim 11 wherein the reporting data is utilized to generate a bill for the client.

17. The content provider server device of claim 11 wherein a business owner at one or more of the host locations is paid on a revenue sharing basis by the content provider.

18. The content provider server device of claim 11 wherein one or more of the host locations are grouped together to form a customized group specified by the client in the play instructions.

19. A method for providing a content distribution computer network, the method comprising:
transmitting a playlist specifying one or more audio media files and host locations to one or more player devices at the host locations, the transmitting in response to a request from the one or more player devices for an updated playlist, the audio media files including audio content and attributes, the attributes including a content type and play instructions, each of the player devices at a different host location, each player device identified by a MAC address, wherein the playlist and audio media files are utilized by the player device along with local play sequence rules to build a play queue for broadcast at the host location;
transmitting one of the audio media files to one of the player devices in response to a request from the player device for the audio media file;
creating an audio media file including music audio content from an independent musician client, the creating including: receiving the music audio content; approving the music audio content; editing the approved music audio content to include data about the musician; generating a new audio media file from the edited approved music audio content; adding the new audio media file to the playlist; and
transmitting the playlist and the new audio media file to one or more of the player devices in response to the musician selecting the host locations associated with the player devices and to a request from the player devices for the new audio media file;
receiving broadcast time reporting data for the audio media files in the playlist on a periodic basis;
transmitting the broadcast time reporting data to clients associated with the audio media files in the playlist; and
generating an alert for a player device in response to not receiving the broadcast reporting data within the periodic basis, the alert indicating that the player device may not be operational.

20. A method for distributing media content from a media server to a plurality of player devices located at remote host locations, the method comprising:
providing player devices at the remote host locations and connecting the provided player devices to the media server via a packet-switched network;
creating a media file including music content from a musician client, the creating including: receiving the music content, approving the music content and editing the approved music content to include information about the content type and play instructions;
prompting the independent musician client to select one or more remote host locations for distribution of the music content and receiving client selection of one or more host locations;
creating a media file including advertising content from an independent advertiser client, the creating including: receiving the advertising content, approving the content, and editing the approved content to include information about the content type and play instructions,
prompting the independent advertiser client to select one or more remote host locations for distribution of the advertising content and receiving client selection of one or more host locations;
generating a playlist for each host location selected by the musician and advertiser clients, the playlist includes listing of media files to be distributed at the selected host locations;
transmitting the playlist specifying the plurality of media files to the player devices at the selected host locations, wherein the player devices utilizes the playlist and a local play sequence rules to build a play queue for broadcast of the media files at the host locations;
transmitting one of the media files to one of the player devices in response to a request from the player device for the media file, the transmitted media files include one or more of the music content and advertising content;
receiving from the player devices broadcast time reporting data for the media files in the playlists on a predetermined basis;
transmitting the broadcast time reporting data to the musician and advertisement clients associated with the media files in the playlist; and
receiving payments from the musician and advertisement clients for content distribution.

21. The method of claim 20, further comprising disbursing a portion of the client payment to the host location owner for content distribution.

22. The method of claim 20, wherein the musician client includes one or more of an independent musician, a promoting company, music producer, or other right-holder of distributable music.

23. The method of claim 20, wherein the playlist further includes media control information including, a play sequence, location start/stop times, volume information, software versioning, and reporting software locations.

24. A method for distributing audio content from a media server to a plurality of player devices located at remote host locations, the method comprising:
providing one or more player devices at the remote host locations and connecting the provided player devices to the media server via a packet-switched network;
providing a first Web interface for musicians to submit music content and to select one or more host locations for distribution of the music content;
providing a second Web interface for advertisers to submit advertising content and to select one or more host locations for distribution of the advertising content;
creating one or more media files including one or more of music and advertising content, the creating includes: receiving the content via Web interface, approving the content, and editing the approved content to include information about the content type and play instructions;
storing the one or more media files on the media server;
generating a playlist for each host location selected by the musician and advertiser, the playlist includes listing of media files to be distributed at the selected host locations;
transmitting the playlist specifying the plurality of media files to the player devices at the selected host locations, wherein the player devices utilize the playlist and local play sequence rules to build a play queue for broadcast of the media files at the host locations;
transmitting one of the media files to one of the player devices in response to a request from the player device for the media file, the transmitted media files include one or more of the music content and advertising content;
receiving from the player devices broadcast time reporting data for the media files in the playlists on a predetermined basis;
troubleshooting the player device in the event of not receiving time reporting data from the player device on time.

25. The method of claim 24, wherein troubleshooting includes one or more of checking network connection of the player device, confirming that the playlist is on the player device, re-downloading the playlist, rebooting the player device, updating the playlist, uploading the requested media file, and contacting the host location.

26. A method for distributing audio content, the method comprising:
entering into a contract with one or more host location owners for distribution of the audio content at one or more host locations;
entering into a contract with one or more musician clients, whereby a musician agrees to provide music content for distribution at one or more host locations;
entering into a contract with one or more advertisers, whereby an advertiser agrees to provide advertising content for distribution at one or more host locations;
providing a Web interface for the musicians and advertisers to provide music and advertising content and to select one or more host locations for distribution of the content;
creating one or more media files including one or more of music and advertising content, the creating includes: receiving the content via the Web interface, approving the content, and editing the approved content to include information about the content type and play instructions;
generating a playlist for each host location selected by the musician and advertiser, the playlist includes listing of media files to be distributed at the selected host locations;
transmitting the playlist specifying the plurality of media files to the player devices at the selected host locations, wherein the player devices utilize the playlist and local play sequence rules to build a play queue for broadcast of the media files at the host locations;
transmitting one of the media files to one of the player devices in response to a request from the player device for the media file, the transmitted media files include one or more of the music content and advertising content;
receiving from the player devices broadcast time reporting data for the media files in the playlists on a predetermined basis;
transmitting the broadcast time reporting data to the musicians and advertisers associated with the media files in the playlist;
receiving payments from the musicians and advertisers for content distribution; and
disbursing a portion of the received payment to the host location owner for content distribution.

27. The method of claim 26, further comprising installing player devices at the remote host locations and connecting the installed player devices to a media server via a packet-switched network.

28. The method of claim 27, further comprising storing the one or more media files on the media server.

29. A system for distributing media content, the system comprising:
a plurality of media players configured to play media content at remote host locations;
a media database configured to store the media content;
a Web interface accessible to musicians and advertisers to provide music and advertising content and to select host locations for distribution of the provided content;
a media server connected to the plurality of media player, the media database and the Web interface, the media server configured to
create one or more media files including one or more of the music and advertising content, the creating includes: receiving the content via the Web interface, approving the content, and editing the approved content to include information about the content type and play instructions;
store the one or more media files in the media database;
generate a playlist for each host location selected by the musician and advertiser, the playlist includes listing of media files to be distributed at the selected host locations;
transmit the playlist specifying the plurality of media files to the player devices at the selected host locations, wherein the player devices utilize the playlist and local play sequence rules to build a play queue for broadcast of the media files at the host locations;
transmit one of the media files to one of the player devices in response to a request from the player device for the media file, the transmitted media files include one or more of the music content and advertising content;
receive from the player devices broadcast time reporting data for the media files in the playlists on a predetermined basis;
transmit the broadcast time reporting data to the musicians and advertisers associated with the media files in the playlist.
